(19) United States
(12) Patent Application Publication
(10) Pub. No.: US 2012/0087354 A1
(43) Pub. Date: Apr. 12, 2012

(54) METHODS AND RECEIVERS FOR PROCESSING TRANSMISSIONS FROM TWO DIFFERENT TRANSMITTING RADIOS

(75) Inventors: Robert D. LoGalbo, Rolling Meadows, IL (US); Kevin G. Doberstein, Elmhurst, IL (US); Bradley M. Hiben, Glen Ellyn, IL (US); Christopher H. Wilson, Lake Zurich, IL (US)

(73) Assignee: MOTOROLA, INC., Schaumburg, IL (US)

(21) Appl. No.: 12/901,818

(22) Filed: Oct. 11, 2010

(51) Int. Cl. H04J 3/00; H04W 72/12; H04W 88/02; H04W 40/00

(52) U.S. Cl. 370/337; 455/509; 370/329; 455/181.1

(57) ABSTRACT

A method and receiver apparatus for a receiving radio unit are disclosed for use in a wireless communication system for processing transmissions from different radio units at the receiving radio unit. A first transmitting radio unit transmits first audio information (e.g., a first audio encoded frame) in a first time slot, and a second transmitting radio unit then transmits second audio information (e.g., a second audio encoded frame) in a second time slot. The receiving radio unit receives radio frequency (RF) signals comprising a first bit stream corresponding to the first audio information, and a second bit stream corresponding to the second audio information. Based on the first bit stream and the second bit stream the receiving radio unit generates a single analog audio signal that comprises combined audio information corresponding to the first audio information and the second audio information.

### FIELD OF THE DISCLOSURE

The present disclosure relates generally to communication networks and more particularly to methods, systems and receiver apparatus for processing audio transmissions received in two different time slots from two different transmitters in a radio communication system, such as, a time division multiple access (TDMA)-based two-way digital radio communication system.

### BACKGROUND

A number of wireless communication systems employ multiple access schemes that utilize time slots. Time division multiple access (TDMA) is a channel access method for shared medium networks. It allows several users to share the same radio frequency (RF) channel by dividing it into different time slots, and assigning each radio unit one or more time slots. The radio units then transmit, each using its own time slot. This allows multiple radio units to share the same transmission medium (e.g. RF channel) while using only a part of its channel capacity. Orthogonal frequency division multiple access (OFDMA) is another channel access method that relies on slots. In OFDMA systems, each RF channel is divided into different sub-channels each having different time slots such that each slot is defined as a combination of a time slot and a frequency sub-channel. TDMA and OFDMA schemes are widely used in cellular networks, Wireless Local Area Networks (WLANs), and Wireless Wide Area Networks (WWANs).

In addition, a number of two-way radio systems have been (or are currently being) developed that employ TDMA as their chosen multiple access scheme. These include land mobile radio systems and two-way radio dispatch systems that are utilized, for example, by police officers, fire fighters, other emergency responders, private security agencies, governmental agencies, hospitals, retail store chains, school systems, utilities companies, transportation companies, construction companies, manufacturing companies, educational institutions, and the like to allow mobile teams to share information instantly.

In many deployments, these two-way radio systems are designed to operate over a wide area network (WAN) that includes multiple sites distributed over a wide area. At each physical site a base station is provided that can be communicatively coupled directly to other base stations deployed at other physical sites. Wireless communication devices located at one particular physical site can then communicate (via the base station) with other wireless communication devices including those located at or near the other physical sites.

In many cases, radio systems such as those described above support group communication or “group call” functionality for allowing simultaneous communications to a group of wireless communication devices. As used herein, the term “call” is defined broadly and refers to any exchange of information between members of a communication group including voice, data, and control signaling.

In these systems, a receiving wireless communication device (WCD) has a receiver that is designed to process information received on one time slot at any given time. The receiver of the receiving WCD does not process information received on another time slot. As such, the receiving WCD is capable of hearing a transmission from one transmitting radio unit (e.g., one transmitting WCD or one transmitting BS) at any particular time, and transmissions received from other transmitting radio units are ignored (e.g., not heard at the receiving WCD). System designers have intentionally designed the demodulation processor and vocoder used in such wireless communication devices to process only one time slot, and ignore information received in a second time slot. In this manner, the user of the receiving WCD can avoid hearing multiple transmitting WCDs at the same time, thereby preventing the transmissions from interfering with each other.

However, in some time slot-based wireless communication systems, scenarios may arise where it is desirable for a user of a particular receiving wireless communication device to be able to hear communications transmitted from two different transmitting sources. This would allow a user to simultaneously hear audio from two different transmitting WCDs. The transmitting sources could be, for example, another wireless communication device transmitting directly to the receiving wireless communication device, or a base station/repeater that is transmitting to the receiving wireless communication device. Because conventional wireless communication devices are only designed to process communications being transmitted by a single source on a particular time slot, a conventional receiving wireless communication device is unable to hear transmissions from a second source on a second time slot when a call is and taking place on the first time slot. In fact, there is no indication at the receiving WCD that another transmitting WCD is attempting to communicate. One example where it would be desirable to simultaneously hear transmissions on different time slots is an emergency situation where two or more wireless communication devices are attempting to transmit critical transmissions simultaneously.

It would be desirable to provide systems, methods and receiver apparatus that allow a wireless communication device to simultaneously listen to transmissions from two other wireless communication devices that are transmitting over different time slots.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram which illustrates a two-way radio communications network in which various embodiments can be implemented;

FIG. 2 is a block diagram illustrating a conventional receiver at a receiving radio unit that is designed to receive a transmission from a transmitting radio unit;

FIG. 3 is a flow chart illustrating a method for receiving transmissions from two different transmitting radio units in different time slots at a receiving radio unit, and processing those transmissions to generate an audio stream that includes audio information from both transmissions in accordance with some of the disclosed embodiments;

FIG. 4 is a timing diagram that illustrates bursts of compressed encoded audio information transmitted by a first transmitting radio unit that is assigned a first time slot (time slot 0), and by a second transmitting radio unit that is assigned a second time slot (time slot 1);

FIG. 5 is a block diagram illustrating a receiver implemented at a receiving radio unit in accordance with some of the disclosed embodiments;

FIG. 6 is a block diagram illustrating an audio decoder module that can be implemented at the receiver of FIG. 5 in accordance with some of the disclosed embodiments; and

FIG. 7 is a block diagram illustrating an audio decoder module that can be implemented at the receiver of FIG. 5 in accordance with some of the other disclosed embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Embodiments of the present invention generally relate to communications in a two-way wireless communication system. Methods, systems and receiver apparatus are disclosed for allowing a wireless communication device to simultaneously listen to transmissions from two other wireless communication devices that are transmitting over different time slots.

In one embodiment, a method and receiver apparatus for a receiving radio unit are provided for use in a wireless communication system for processing transmissions from different radio units at the receiving radio unit. A first transmitting radio unit transmits first audio information (e.g., a first audio encoded frame) in a first time slot, and a second transmitting radio unit then transmits second audio information (e.g., a second audio encoded frame) in a second time slot. The receiving radio unit receives radio frequency (RF) signals comprising a first bit stream corresponding to the first audio information that was transmitted in the first time slot, and a second bit stream corresponding to the second audio information that was transmitted in the second time slot. Based on the first bit stream and the second bit stream the receiving radio unit generates a single analog audio signal that comprises combined audio information corresponding to the first audio information and the second audio information.

For example, in one implementation, the receiving radio unit can demodulate the first bit stream to generate the first bit stream of audio encoded bits corresponding to the first encoded audio frame, and separately demodulate the second bit stream to generate a second bit stream of other audio encoded bits corresponding to the second encoded audio frame. The first and second bit streams can then be separately decoded to generate a first stream of digitized audio samples and a second stream of digitized audio samples that can then be combined to generate a single audio stream of digital audio samples, which may then be converted into a single analog audio signal that can be amplified and input to a speaker to generate an acoustic signal.

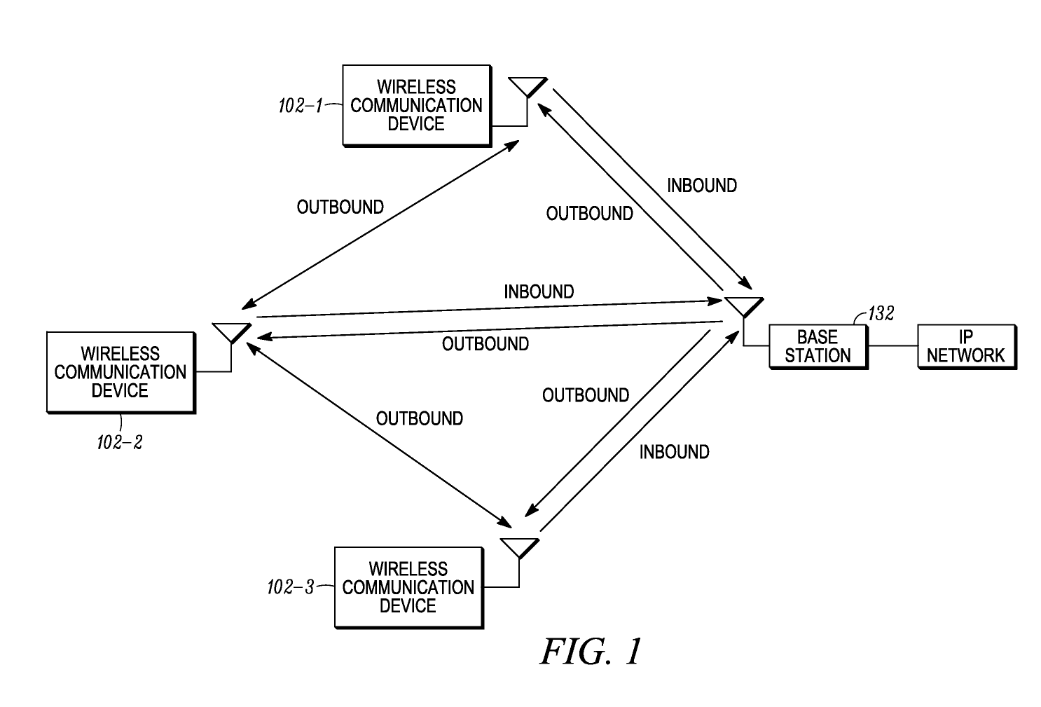

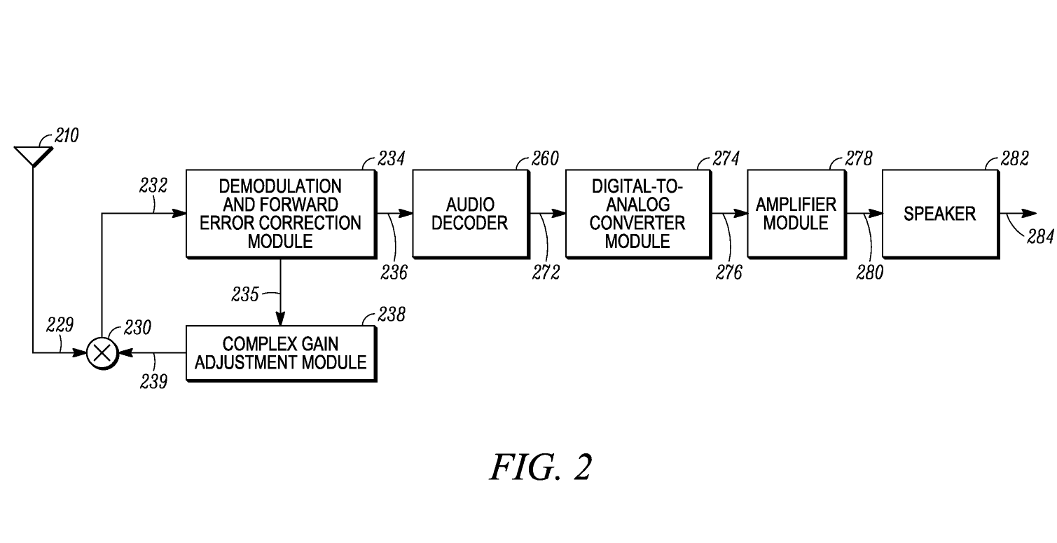

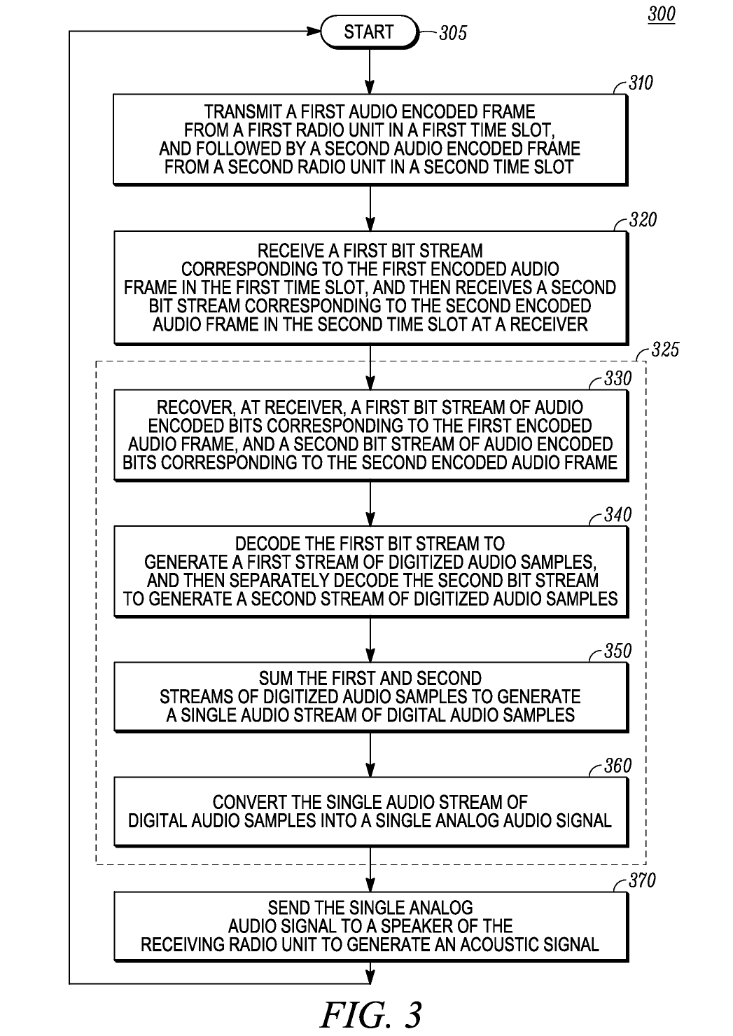

Embodiments of the present invention can apply to a number of network configurations. Prior to describing some embodiments with reference to FIGS. 3-7, one example of a network configuration in which these embodiments can be applied will now be described with reference to FIG. 1, followed by a brief description of a conventional TDMA receiver chain with reference to FIG. 2.

FIG. 1 is a block diagram which illustrates a two-way radio communications network 100 in which various embodiments can be implemented.

As illustrated in FIG. 1, the network 100 may include one or more base stations 132 that are communicatively coupled to an Internet Protocol (IP) network 140 via a communication link, and a plurality of wireless communication devices (WCDs) 102-1, 102-2, 102-3. In one implementation, the communication link can be an Internet Protocol (IP) based communication link for transferring information between the base stations. The network 100 illustrated in FIG. 1 is a simplified representation of one particular network configuration, and many other network configurations are possible. Although not illustrated in FIG. 1, it will be appreciated by those skilled in the art that the network can include additional base stations and/or additional WCDs that are not illustrated for sake of convenience. For ease of illustration, only three wireless communication devices and one base station are shown. However, those skilled in the art will appreciate that a typical system can include any number of wireless communication devices and any number of base stations distributed about in any configuration, where the base stations are communicatively coupled to one another via IP network 140. It will be appreciated by those of ordinary skill in the art that the base station 132 and the WCDs 102-1, 102-2, 102-3 can be, for example, part of a wide area network (WAN) that is distributed over a wide area that spans multiple access networks.

Examples of such networks 100 are described in a number of standards that relate to digital two-way radio systems. Examples of such standards include, the Terrestrial Trunked Radio (TETRA) Standard of the European Telecommunications Standards Institute (ETSI), Project 25 of the Telecommunications Industry Association (TIA) and ETSI's digital wireless communication device (DMR) Tier-2 Standard, which are incorporated by reference herein in their entirety. The TETRA standard is digital standard used to support multiple communication groups on multiple frequencies, including one-to-one, one-to-many and many-to-many calls. The TETRA standards and DMR standards have been and are currently being developed by the European Telecommunications Standards Institute (ETSI). The ETSI DMR Tier-2 standard is yet another digital radio standard that describes such two-way peer-to-peer communication system. Any of the TETRA standards or specifications or DMR standards or specifications referred to herein may be obtained by contacting ETSI at ETSI Secretariat, 650, route des Lucioles, 06921 Sophia-Antipolis Cedex, FRANCE. Project 25 defines similar capabilities, and is typically referred to as Project 25 Phase I and Phase II. Project 25 (P25) or APCO-25 refer to a suite of standards for digital radio communications for use by federal, state/province and local public safety agencies in North America to enable them to communicate with other agencies and mutual aid response teams in emergencies. The Project 25 (P25) specifies standards for the manufacturing of interoperable digital two-way wireless communications products. Developed in North America under state, local and federal representatives and Telecommunications Industry Association (TIA) governance, P25 is gaining worldwide acceptance for public safety, security, public service, and commercial applications. The published P25 standards suite is administered by the Telecommunications Industry Association (TIA Mobile and Personal Private Radio Standards Committee TR-8). Any of the P25 standards or specifications referred to herein may be obtained at TIA, 2500 Wilson Boulevard, Suite 300, Arlington, Va. 22201.

The illustrated wireless communication devices 102, which may be, for example, a portable/mobile radio, a personal digital assistant, a cellular telephone, a video terminal, a portable/mobile computer with a wireless modem, or any other wireless communication device. For purposes of the following discussions, the communication devices will be referred to as “wireless communication devices,” but they are also referred to in the art as subscriber units, mobile stations, mobile equipment, handsets, mobile subscribers, or an equivalent.

As illustrated, for example, the wireless communication devices 102 communicate over wireless communication links with base station 132. The base station 132 may also be referred to as a base radio, repeater, access point, etc. The base station 132 includes, at a minimum, a repeater and a router and can also include other elements to facilitate the communications between WCDs 102 and an Internet Protocol (IP) network 140.

As used herein, the term “inbound” refers to a communication originating from a portable wireless communication device that is destined for a fixed base station, whereas the term “outbound” refers to a communication originating from a fixed base station that is destined for a wireless communication device. When two wireless communication devices are communicating in direct mode (also known as talk-around mode), the wireless communication devices can communicate using time slots normally reserved for outbound communications from a base station to a wireless communication device.

In some implementations, the WCDs 102-1, 102-2, 102-3 can communicate with each other through base station 132. As is known by one of ordinary skill in the art, a base station generally comprises one or more repeater devices that can receive a signal from a transmitting wireless communication device over one wireless link and re-transmit to listening wireless communication devices over different wireless links. For example, wireless communication device 102-1 can transmit over an inbound wireless link to base station 132 and base station 132 can re-transmit the signal to listening wireless communication devices such as WCDs 102-2, 102-3 over another outbound wireless link. In addition, WCDs 102-1, 102-2, 102-3 may communicate with the other wireless communication devices (not shown) that are located in other “zones.”

Moreover, although communication between wireless communication devices can be facilitated by base station 132, in some implementations the wireless communication devices 102 can communicate directly with each other when they are in communication range of each other using a direct mode of operation without assistance of a base station. When communicating direct mode, the wireless communication devices 102 communicate directly with each other using time slots normally reserved for outbound communications.

The wireless communication devices 102-1, 102-2, 102-3 and the base station 132 each comprise a radio unit that includes a processor and a transceiver. Each transceiver includes a transmitter and a receiver for transmitting and receiving radio frequency (RF) signals, respectively. Typically, both the wireless communication devices and the base stations, further comprise one or more processing devices (such as microprocessors, digital signal processors, customized processors, field programmable gate arrays (FPGAs), unique stored program instructions (including both software and firmware), state machines, and the like.) and memory elements for performing (among other functionality) the air interface protocol and channel access scheme supported by network 100. As will be described below, using these protocols, wireless communication devices can each generate RF signals that are modulated with information for transmission to the other WCDs or to the base stations.

In one implementation of the network 100, the base station 132 and WCDs 102 can communicate with one another using an inbound 25 kilo Hertz (kHz) frequency band or channel and an outbound 25 kHz frequency band or channel. In other implementations, inbound and outbound channels have a different bandwidth (e.g., 12.5 kHz, 6.25 kHz, etc) can be implemented.

Those skilled in the art will appreciate that the base stations and wireless communication devices may communicate with one another using a variety of air interface protocols or channel access schemes. For example, it may be desirable to improve or increase “spectral efficiency” of such systems so that more end-users can communicate more information in a given slice of RF spectrum. Thus, in some two-way digital radio systems, a particular channel, such as the 25 kHz channel described above, that historically carried a single call at a given time can be divided to allow for a single channel to carry two (or more) calls at the same time. For example, in the context of one implementation described above, for instance, the 25 kHz inbound and outbound sub-channels can be further divided using either Time-Division Multiple Access (TDMA) Orthogonal Frequency-Division Multiple Access (OFDMA) multiple access technologies to increase the number of WCDs that can simultaneously utilize those sub-channels. As will be described below, the disclosed embodiments can apply to any wireless communication system that implements a multiple access scheme that employs a frame structure which includes two or more time slots, including narrowband digital two-way radio wireless communication systems as described below.

For example, TDMA preserves the full channel width, but divides a channel into alternating time slots that can each carry an individual call. Examples of radio systems that utilize TDMA include those specified in the Terrestrial Trunked Radio (TETRA) Standard, the Telecommunications Industry Association (TIA) Project Phase II 25 Standard, and the European Telecommunications Standards Institute's (ETSI) Digital Mobile Radio (DMR) standard. Project 25 Phase II and the ETSI DMR Tier-2 standard implement two-slot TDMA in 12.5 kHz channels, whereas the TETRA standard that uses four-slot TDMA in 25 kHz channels.

For instance, a 12.5 kHz inbound sub-channel can be further divided into two alternating time slots so that a particular WCD can use the entire 12.5 kHz inbound sub-channel during a first time slot to communicate with the base station, and another wireless communication device can use the entire 12.5 kHz inbound sub-channel during a second time slot to communicate with the base station. Similarly, use of the 12.5 kHz outbound sub-channel can also be divided into two alternating time slots so that the particular base station can use the entire 12.5 kHz outbound sub-channel to communicate with a particular wireless communication device (or communication group of wireless communication devices) during a first time slot, and can use the entire 12.5 kHz outbound sub-channel to communicate with another particular wireless communication device (or another communication group of wireless communication devices) during a second time slot. As one example, Project 25 Phase 2 TDMA uses twelve (12) 30 millisecond time slots in each superframe. Each time slot has a duration of 30 milliseconds and represents 360 bits.

Project 25 Phase 2 TDMA uses two different modulation schemes to modulate data streams for over-the-air transmission in a 12.5 kHz channel. The first scheme, called harmonized continuous phase modulation (H-CPM), is used by the WCDs for uplink inbound transmission. H-CPM is a common constant-envelope modulation technique. The second scheme, called harmonized differential quadrature phase shift keyed modulation (H-DQPSK), is used at base stations for downlink outbound transmissions. H-DQPSK is a non-coherent modulation technique that splits the information stream into two channels, delays one channel by 90° in phase (quadrature) and then recombines the two phase shift keyed channels using differential coding (encoding the difference of the current data word applied to the transmitter with its delayed output). Combining two channels in quadrature (again, 90° out of phase with each other) lowers the transmitted baud rate, improving the transmitted spectral characteristics. H-DQPSK modulation requires linear amplifiers at the base station.

Regardless of the multiple access technique that is implemented, the RF resources available for communicating between a base station and its associated wireless communication devices are limited. One example of an RF resource is a time slot in TDMA-based systems, and another example is a frequency sub-channel within a particular time slot in OFDMA-based systems. At any given time, a single RF resource can be allocated to either a communication group (e.g., one WCD communicating with two or more other WCDs) or a communication pair (e.g., two WCDs communicating only with each other).

Each WCD 102-1, 102-2, 102-3 can belong to one or more communication groups in which each has its own communication group identifier. Each of the members of a particular communication group share a communication group identifier that distinguishes those WCDs from other WCDs in the network that do not belong to the communication group. The WCDs belonging to a particular communication group are authorized to receive communications intended for that particular communication group, and/or to transmit communications intended for that particular communication group. In conventional systems, the wireless communication devices 102 may participate in one call for a communication group at any particular time. Upon coming within communication range of the base station 132, each WCD registers with that particular base station. When a WCD associates with a particular base station, the WCD registers its device identifier (e.g., Media Access Control (MAC) address) and its communication group identifiers (CGIs) with that particular base station.

As mentioned above, at any given time, a receiving wireless communication device will only process communications from one base station or one transmitting wireless communication device. In other words, the receiving wireless communication device will process communications it receives in one time slot, and ignore those it receives in another time slot. Thus, if two transmitting sources attempt to communicate with the receiving wireless communication device at approximately the same time, then the communication from only one of those transmitting sources will be processed and heard at the receiving wireless communication device. This will now be explained further in greater detail with reference to FIG. 2.

FIG. 2 is a block diagram illustrating a conventional receiver 200 at a receiving radio unit that is designed to receive a transmission from a transmitting radio unit. In this particular non-limiting example, it is presumed that the receiver 200 is operating in a two-slot TDMA wireless communication system that implements a TDMA-based multiple access scheme. Depending on the implementation, the transmitting radio unit and the receiving radio unit can be implemented at a wireless communication device or a base station/repeater.

As illustrated, the receiver 200 comprises an antenna 210, a first demodulation path for demodulating a received bit stream 229 corresponding to audio encoded information received in a first time slot, an audio decoder module 260, a digital-to-analog converter module 274, an amplifier module 278, and a speaker 282. In the particular implementation illustrated in FIG. 2, the first demodulation path includes a mixer 230, a demodulation and forward error correction (FEC) module 234, and a complex gain adjustment module 238.

The antenna 210 receives modulated RF signals from a particular transmitting radio unit (e.g., from another WCD when communicating in direct mode, or from a base station when operating in repeater mode). The transmitting radio unit transmits frames of audio information for a duration equal to the length of its assigned time slot. Each time slot carries a bit stream that is encoded with audio information.

In this example, for sake of convenience, it is presumed that the particular transmitting radio unit transmits audio information during a first time slot (slot 0) that is alternately transmitted with at least one other time slot successively in time. For sake of convenience, the following description of FIG. 2 will focus on the transmissions that occur during a particular instance of the first time slot. Specifically, the following description will focus on a first audio encoded frame that was transmitted from the transmitting radio unit in a first time slot.

The antenna 210 is coupled to the demodulation path. Although not illustrated, the modulated RF signals can be amplified after being received at the antenna 210.

The demodulation and FEC module 234 comprises analog-to-digital (A/D) converter modules (not illustrated) that are used to generate digital inphase signal (I) and quadrature phase signal (Q) samples (not illustrated) based on the analog RF signal 232. One analog-to-digital converter module samples an analog I signal of the gain-adjusted RF signal 232 to generate a digital complex I sample, and the other analog-to-digital converter module samples an analog Q signal of the gain-adjusted RF signal 232 to generate a digital Q sample.

The complex gain adjustment module 238 uses the digital I/Q samples 235 to generate a complex gain adjustment signal 239. The complex gain adjustment signal is an analog I/Q signal. The complex gain adjustment module 238 applies the complex gain signal 239 to the analog RF signal 229 to modulate the analog RF signal to either a non-zero carrier signal frequency or baseband (zero carrier) so that the I and Q signals are within the dynamic sampling range of the A/D converter modules. In one embodiment, the complex gain adjustment module 238 controls gain applied to the modulated RF signals by generating a complex gain adjustment signal 239 that is multiplied with the modulated RF signals at mixer 230 to generate the gain-adjusted RF signals 232, which can then be provided to a demodulation and forward error correction (FEC) module 234. The RF signal 232 is a bit stream of received bits that includes the first audio encoded frame that was transmitted in time slot 0. Each audio encoded frame includes a bit stream of audio encoded information. In the following description, the RF signal 229 includes a first received bit stream that corresponds to the audio encoded frame transmitted in the particular first time slot. In other words, as the receiving radio unit receives the first bit stream (corresponding to the first encoded audio frame transmitted in a burst during time slot 0), and provides the first bit stream to the first demodulation path for processing.

The demodulation and FEC module 234 demodulates and performs FEC on the gain-adjusted RF signal 232 (including the first bit stream that is received in the first time slot (slot 0)) to recover a first bit stream 236 of audio encoded bits corresponding to the first encoded audio frame. The digital I/Q samples are demodulated and forward error corrected to generate the first bit stream 236. The demodulation and FEC module 234 is synchronized with the frame/slot timing of the transmitting radio unit so that it can determine the start of time slot 0 in the received frame and can demodulate information in time slot 0. The demodulation and FEC module 234 ignores information transmitted in time slot 1 and will not bother demodulating bits that are received in time slot 1. After processing the information received in time slot 0, the demodulation and FEC module 234 will output a bit stream 236 of audio encoded bits corresponding to time slot zero along with soft error control information generated during FEC processing. The soft error control information generated by demodulation and FEC module 234 can include log-likelihood ratios (LLRs) and FEC erasures.

The audio decoder module 260 processes or decodes the first bit stream 236 to generate an audio stream 272 of digital audio (e.g., voice) samples. The decoding performed by audio decoder module 260 varies depending on the implementation. The audio decoder module can be one module of a vocoder module. The audio decoder modules can be those defined in any known vocoder architecture including a dual-rate vocoder specified in Project 25 Phase 2 TDMA. As will be appreciated by those skilled in the art, a speech coder (or vocoder) is generally viewed as including an audio encoder and an audio decoder. The audio encoder produces a compressed stream of bits from a digital representation of speech based on an analog signal produced by a microphone. When the bit stream is received, the audio decoder converts the compressed bit stream into a digital representation of speech that is suitable for playback through a digital-to-analog converter and a speaker. In most applications, the audio encoder and the audio decoder are physically separated, and the bit stream is transmitted between them using a communication channel such as a wireless or over the air link. Examples of vocoder systems include linear prediction vocoders such as Mixed-Excitation Linear Predictive (MELP) vocoders, homomorphic vocoders, channel vocoders, sinusoidal transform coders (“STC”), harmonic vocoders and multiband excitation (“MBE”) vocoders.

To code and decode speech, linear predictive coding (LPC) can be used to predict each new frame of speech from previous samples using short and long term predictors. Alternatively, model-based speech coders or vocoders can be used, in which the vocoder models speech as the response of a system to excitation over short time intervals. Speech is divided into short segments, with each segment being characterized by a set of model parameters that represent a few basic elements of each speech segment, such as the segment's pitch, voicing state, and spectral envelope. A vocoder may use one of a number of known representations for each of these parameters. For example, the pitch may be represented as a pitch period, a fundamental frequency or pitch frequency (which is the inverse of the pitch period), or as a long-term prediction delay. Similarly, the voicing state may be represented by one or more voicing metrics, by a voicing probability measure, or by a set of voicing decisions.

The MBE vocoder is a harmonic vocoder based on the MBE speech model. The MBE vocoder combines a harmonic representation for voiced speech with a flexible, frequency-dependent voicing structure based on the MBE speech model. The MBE speech model represents segments of speech using a fundamental frequency corresponding to the pitch, a set of voicing metrics or decisions, and a set of spectral magnitudes corresponding to the frequency response of the vocal tract. The MBE speech model generalizes the traditional single voice/unvoiced (V/UV) decision per segment into a set of decisions, each representing the voicing state within a particular frequency band or region. Each frame is thereby divided into at least voiced and unvoiced frequency regions.

MBE-based vocoders include the Improved Multi-Band Excitation (IMBE) speech coder and the Advanced Multi-Band Excitation (AMBE) speech coder. The IMBE speech coder has been used in a number of wireless communications systems including the APCO Project 25 mobile radio standard. The AMBE speech coder uses a filter bank that typically includes sixteen channels and a non-linearity to produce a set of channel outputs from which the excitation parameters can be reliably estimated. The channel outputs are combined and processed to estimate the fundamental frequency. Thereafter, the channels within each of several (e.g., eight) voicing bands are processed to estimate a binary voicing decision for each voicing band. In the AMBE+2 vocoder, a three-state voicing model (voiced, unvoiced, pulsed) is applied to better represent plosive and other transient speech sounds. Various methods for quantizing the MBE model parameters have been applied in different systems. Typically the AMBE vocoder and AMBE+2 vocoder employ more advanced quantization methods, such as vector quantization, that produce higher quality speech at lower bit rates.

The dual-rate vocoder includes the existing Phase 1 full-rate IMBE vocoder (7.2 kilo bits per second (kb/s)) and extensions for the enhanced half-rate vocoder (3.6 kb/s). The enhanced half-rate IMBE vocoder is used for voice operations. The 12 kb/s bit rate for Phase 2 is the sum of two 3.6 kb/s streams for the two enhanced half-rate IMBE vocoders (2×3.6=7.2) plus the 4.8 kb/s associated link management and in-channel signaling to support two voice paths in the channel.

The audio decoder module 260 processes each frame of bits for one time slot to produce a corresponding frame of (synthesized) digital speech samples. The frame of digital speech samples are part of stream of digital speech samples that make up a digital speech signal that represents digital speech.

The audio decoder module 260 is coupled to the digital-to-analog converter module 274. The digital-to-analog converter module 274 converts the audio stream 272 of digital audio samples into an analog audio signal 276. The digital-to-analog converter module 274 is coupled to the optional amplifier module 278, which is coupled to the speaker 282. The amplifier module 278 amplifies the analog audio signal 276 prior to providing it to the speaker 282. The speaker 282 receives the amplified analog audio signal 280 and generates an acoustic signal 284. This acoustic signal 284 will include audio information that was transmitted from the transmitting radio unit, thereby enabling a user of the receiving radio unit to hear audio transmitted from a user of the transmitting radio unit.

The disclosed embodiments provide systems, methods and receiver apparatus that allow a wireless communication device to simultaneously listen to transmissions from two other wireless communication devices that are transmitting over different time slots.

FIG. 3 is a flow chart illustrating a method 300 for receiving transmissions from two different transmitting radio units in different time slots at a receiving radio unit, and processing those transmissions to generate an audio stream that includes audio information from both transmissions in accordance with some of the disclosed embodiments. In the disclosed embodiments, the transmitting radio unit can be implemented at a wireless communication device or a base station/repeater, and the receiving radio unit can be implemented at a wireless communication device or a base station/repeater. For instance, in one implementation, the transmitting radio units and the receiving radio unit can be wireless communication devices that are communicating in direct or talk-around mode without assistance of a base station. In another implementation, the receiving radio unit can be a wireless communication device, and the transmitting radio units can be wireless communication devices that are communicating in indirect or repeater mode with assistance of a base station. In another implementation, the receiving radio unit can be a base station, and the transmitting radio units can be wireless communication devices. In another implementation, the receiving radio unit can be a wireless communication device, and one or both of the transmitting radio units can be base stations.

The method 300 can be used in conjunction with any type of wireless communication system that implements time slots including, but not limited to, a TDMA-based wireless communication system, an OFDMA-based wireless communication system, or an equivalent. In one non-limiting implementation, a first transmitting radio unit, a second transmitting radio unit and a receiving radio unit that will be described below are members of the same communication group. Furthermore, in some implementations, the second transmitting radio unit may have a higher priority than the first transmitting radio unit.

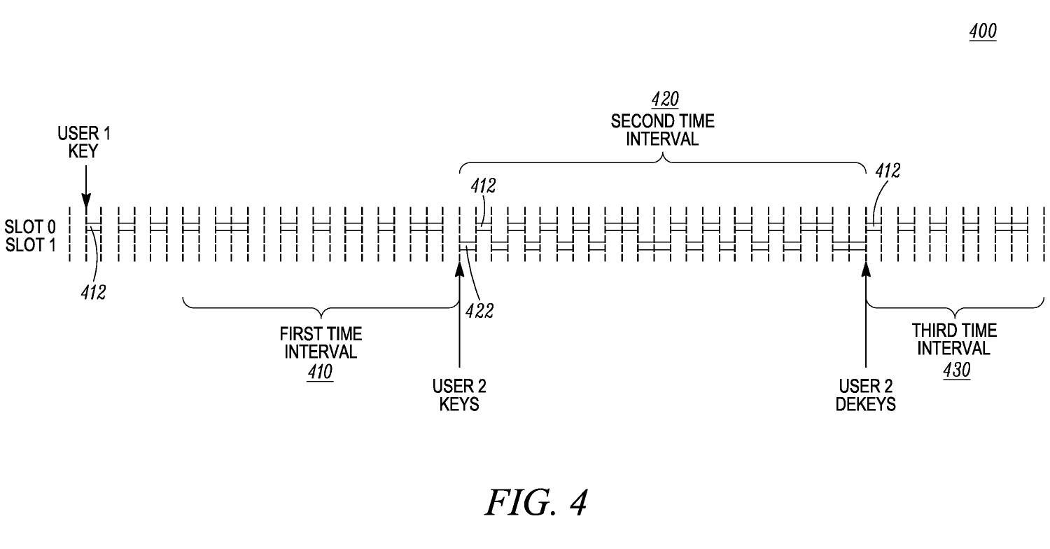

The method 300 starts at operation 305, and at operation 310, a first audio encoded frame is transmitted from a first transmitting radio unit in a first time slot (e.g., time slot 0), and a second audio encoded frame is then transmitted from a second transmitting radio unit in a second time slot (e.g., time slot 1). The first time slot and the second time slot can be, but are not limited to, consecutive time slots that are transmitted successively in time. An example is illustrated in the time slot timing diagram 400 of FIG. 4.

In FIG. 4, each rectangle represents a burst of compressed encoded audio information transmitted in a time slot. For instance, in one implementation where each time slot is 30 milliseconds (ms) in length, the compressed burst of encoded audio information carried in that time slot would include 60 ms of audio information so that enough audio samples can be generated and stored in a buffer while the receiver is waiting to receive the next burst in that time slot.

A first transmitting radio unit is assigned a first time slot (time slot 0), and a second transmitting radio unit is assigned a second time slot (time slot 1). As illustrated in FIG. 4, during the first time interval 410, the first transmitting radio unit is transmitting on the first time slot 412 (e.g., time slot 0). For example, a user of the first transmitting radio unit keys up and his audio is heard by all users in the system. During a second time interval 420, while the first transmitting radio unit continues transmitting, the second transmitting radio unit also begins transmitting on the second time slot 422 (e.g., time slot 1), while the first transmitting radio unit continues transmitting on the first time slot 412 (e.g., time slot 0). For instance, a user of the second transmitting radio unit may have an emergency and also attempts to key up, and because the second transmitting radio unit is already synchronized to TDMA frame timing of the first transmitting radio unit, the second transmitting radio unit will use the alternate or second time slot when it keys up. As will now be described below, during the second time interval 420 when both users are keyed up, all listeners (e.g., the receiving radio unit) will simultaneously hear transmissions on both the first time slot 412 (e.g., time slot 0) from the first transmitting radio unit and the second time slot 422 (e.g., time slot 1) from the second transmitting radio unit. In this manner, both users will be heard during the second time interval 420. When the user of the second transmitting radio unit dekeys during a third time interval 430, the listeners will then hear audio transmissions (e.g., voice) from the first transmitting radio unit since it continues transmitting on the first time slot 412 (e.g., time slot 0).

Referring back to FIG. 3, at operation 320, a receiving radio unit receives a first bit stream corresponding to the first encoded audio frame in the first time slot, and then receives a second bit stream corresponding to the second encoded audio frame in the second time slot. For example, with reference to FIG. 4, during this second time interval 420, the receiving radio unit will receive the first bit stream and the second bit stream, and process audio encoded information received on both the first time slot 412 and the second time slot 422.

At operation 325, the receiving radio unit generates a single analog audio signal that comprises first audio information corresponding to the first encoded audio frame and second audio information corresponding to the second encoded audio frame. As will now be described, in one implementation of operation 325, operation 325 may comprise at least steps 330 through 370.

At operation 330, a first bit stream of audio encoded bits corresponding to the first encoded audio frame, and a second bit stream of audio encoded bits corresponding to the second encoded audio frame are recovered at the receiving radio unit. For example, in one implementation, the receiving radio unit can demodulate and perform forward error correction on the first bit stream to generate the first bit stream of audio encoded bits that correspond to the first encoded audio frame. The receiving radio unit can separately demodulate and perform forward error correction on the second bit stream to generate a second bit stream of other audio encoded bits that correspond to the second encoded audio frame.

At operation 340, the receiving radio unit can decode the first bit stream to generate a first stream of digitized audio samples, and separately decode the second bit stream to generate a second stream of digitized audio samples. In one embodiment, each time slot is 30 milliseconds in duration and includes 60 milliseconds of audio information that is represented using 480 audio samples. When time slot 0 is received, 60 milliseconds of audio information (or 480 digitized audio samples) are generated and held in a buffer that can be implemented in the audio decoder. Similarly, when time slot 1 is received, 30 milliseconds after time slot 0, 60 milliseconds of audio information (or 480 additional digitized audio samples) are generated and held in another buffer that can be implemented in the audio decoder.

At operation 350, the receiving radio unit can sum the first and second streams of digitized audio samples to generate a single audio stream of digital audio samples. For example, once all of the digitized audio samples are generated and buffered, the receiving radio unit can sum digitized audio sample 0 from time slot 0 and digitized audio sample 0 from time slot 1, then sum digitized audio sample 1 from time slot 0 and digitized audio sample 1 from time slot 1, then sum digitized audio sample 2 from time slot 0 and digitized audio sample 2 from time slot 1, . . . , then sum digitized audio sample X from time slot 0 and digitized audio sample X from time slot 1, and then sum digitized audio sample 479 from time slot 0 and digitized audio sample 479 from time slot 1.

At operation 360, the receiving radio unit can convert the single audio stream of digital audio samples into a single analog audio signal, and at operation 370, can send the single analog audio signal to a speaker of the receiving radio unit to generate an acoustic signal that includes audio information transmitted by the first transmitting radio unit and by the second transmitting radio unit. In this manner, the user of the receiving wireless communication device (that includes the receiving radio unit) can simultaneously hear or listen to audio from both of the first and second transmitting radio units.

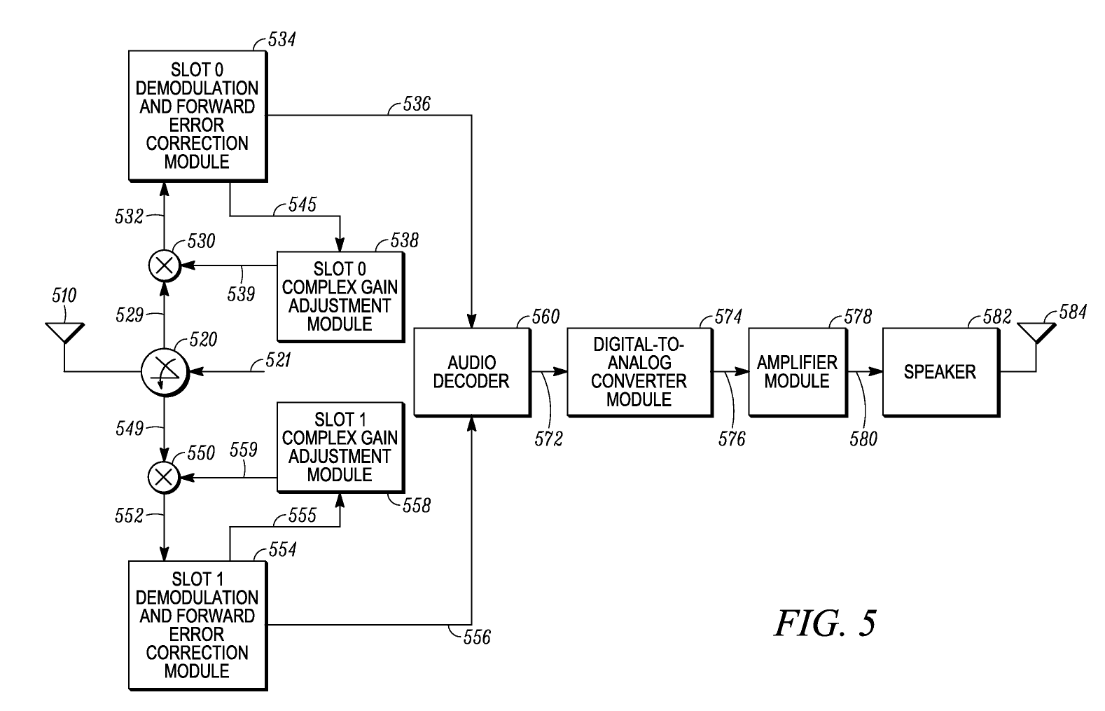

FIG. 5 is a block diagram illustrating a receiver 500 implemented at a receiving radio unit in accordance with some of the disclosed embodiments. In this particular non-limiting example, it is presumed that the receiver 500 is operating in a two-slot TDMA wireless communication system that implements a TDMA-based multiple access scheme. As will be described below, the receiver 500 of the receiving radio unit is designed to receive transmissions from different transmitting radio units and process those transmissions to generate a single audio stream 572. The transmitting radio units can be implemented at a wireless communication device or a base station/repeater, and the receiving radio unit can be implemented at a wireless communication device or a base station/repeater.

As illustrated, the receiver 500 comprises an antenna 510, a switch 520, a first demodulation path that comprises at least a mixer 530, a demodulation and FEC module 534, and a complex gain module 538 for demodulating a first bit stream 529 corresponding to audio encoded information received in first time slots, a second demodulation path comprises at least a mixer 550, a demodulation and FEC module 554, and a complex gain module 558 for demodulating a second bit stream 549 corresponding to audio encoded information received in second time slots, an audio decoder module 560, a digital-to-analog converter module 574, an optional amplifier module 578, and a speaker 582.

The antenna 510 receives modulated RF signals transmitted from different transmitting radio units. Each of the transmitting radio units transmits frames of encoded audio information. Each frame has a duration equal to the length of its assigned time slot, which is 30 milliseconds in one non-limiting implementation. Each time slot carries a bit stream that is encoded with audio information.

For sake of discussion, in the example that follows, it is presumed that a first transmitting radio unit transmits audio information during a first time slot, and that a second transmitting radio unit transmits its audio information during a second time slot. An example is illustrated in FIG. 4 as described above, where during interval 420, the first transmitting radio unit and the second transmitting radio unit alternately transmit during their respective first time slot (slot 0) 412 and second time slot (slot 1) 422. In one implementation that corresponds to a two-slot TDMA system, the first time slot 412 and the second time slot 422 can be consecutive time slots that are transmitted successively in time. For sake of convenience, the following description of FIG. 5 will focus on the transmissions that occur during particular instances of the first time slot 412 and the second time slot 422. In particular, the following description will focus on a first audio encoded frame that was transmitted from the first transmitting radio unit in the first time slot 412, and a second audio encoded frame that was transmitted from the second transmitting radio unit in the second time slot 422.

The antenna 510 is coupled to switch 520. Switch 520 is controlled in accordance with a frame timing synchronization signal 521 so that switching of the switch 520 is synchronized with transmissions in the first time slot (slot 0) and the second time slot (slot 1). The switch 500 alternately switches in accordance with a timing pattern to provide audio encoded frames transmitted in the first time slot (slot 0) to the first demodulation path, and to provide other audio encoded frames transmitted in the second time slot (slot 1) to the second demodulation path. The frame timing synchronization signal 521 causes the switch 522 to switch in synchronization with the frame timing of the transmitting radio units at regular intervals, for example, every 30 ms in one implementation. The frame timing synchronization signal 521 can be generated using a variety of different techniques that depend on whether the receiving radio unit and the transmitting radio units are communicating in direct mode or repeater mode.

For example, when the radio units are communicating in repeater mode, the base station regularly transmits a pilot frame or beacon signal to provide an indication of where the first time slot (time slot 0) begins. Each frame has a fixed time length, and therefore if the receiving radio unit knows where time slot 0 begins it can synchronize frame and slot timing with the base station.

By contrast, when the radio units are communicating in direct or talk-around mode, the base station is not involved and hence no pilot or beacon signal is available to use for synchronization. When operating in direct or talk-around mode, the radio units can transmit a special frame synchronization pattern that indicates the start of a time slot 0 or the start of each time slot. The frame synchronization pattern can be a known and defined pattern of bits, and in one implementation is 48 bits in length. When the radio units can detect a bit pattern indicative of the frame synchronization pattern, the radio units can recognize that a time slot is beginning. In some systems, a frame synchronization pattern is transmitted once per frame, and in other systems a frame synchronization pattern is transmitted once per time slot. For example, in a Project 25 two-slot TDMA system, two different frame synchronization patterns can be used for each slot. The radio units can then count a number of bits (or symbols, where each symbol is two bits) after the frame sync to determine where the end of the frame is and hence determine the frame and symbol timing.

Each audio encoded frame includes a bit stream of audio encoded information. In the following description, a first received bit stream 529 corresponds to the audio encoded frame transmitted in the particular first time slot 412, and a second received bit stream 549 corresponds to the audio encoded frame transmitted in the particular second time slot 422. In other words, as the receiving radio unit receives the first bit stream 529 (corresponding to the first encoded audio frame transmitted in a burst during in the first time slot 412), the switch 510 will switch such that the first bit stream 529 (corresponding to the first audio encoded frame transmitted in the first time slot (slot 0) 412 is provided to the first demodulation path, and then switches when the second time slot (slot 1) 422 begins such that the second bit stream 549 (corresponding to the second audio encoded frame transmitted in the second time slot (slot 1) 422 is provided to the second demodulation path for processing

In the particular implementation illustrated in FIG. 5, the first demodulation path comprises at least a mixer 530, a demodulation and FEC module 534, and a complex gain module 538. The complex gain module 538 controls gain applied to the first bit stream 529 that is received in the first time slot (slot 0) 412 to generate a first gain-adjusted bit stream 532.

The demodulation and FEC module 534 comprises analog-to-digital (A/D) converter modules (not illustrated) that are used to generate digital I and Q samples (not illustrated) based on the analog RF signal 532. One analog-to-digital converter module samples an analog I signal of the gain-adjusted RF signal 532 to generate digital complex I samples, and the other analog-to-digital converter module samples an analog Q signal of the gain-adjusted RF signal 532 to generate digital Q samples.

The complex gain adjustment module 538 uses the digital I/Q samples 535 to generate a complex gain adjustment signal 539. The complex gain adjustment signal is an analog I/Q signal. The complex gain adjustment module 538 applies the complex gain signal 539 to the analog RF signal 529 to modulate the analog RF signal to either a non-zero carrier signal frequency or baseband (zero carrier) so that the I and Q signals are within the dynamic sampling range of the A/D converter modules. In one embodiment, the complex gain adjustment module 538 controls or adjusts gain applied to the first bit stream 529 by generating a complex gain adjustment signal 539 that is multiplied with the first bit stream 529 at the mixer 530 to generate the first gain-adjusted bit stream 532, which can then be provided to a demodulation and forward error correction (FEC) module 534 so that the first gain-adjusted bit stream 532 (provided to the demodulation and FEC module 534) is within the dynamic range of an A/D converter module (not illustrated) that is implemented within the demodulation and FEC module 534. The first gain-adjusted bit stream 532 is a first bit stream of received bits that includes the first audio encoded frame that was transmitted in time slot 0. The demodulation and FEC module 534 demodulates and performs FEC on digital I/Q samples of the first gain-adjusted bit stream 532 that are received in the first time slot (slot 0) 412 to recover the first gain-adjusted bit stream 536 of audio encoded bits corresponding to time slot zero along with soft error control information corresponding to the first encoded audio frame. The soft error control information generated during FEC processing includes log-likelihood ratios (LLRs) and FEC erasures.

The second demodulation path comprises at least a mixer 550, a demodulation and FEC module 554, and a complex gain module 558. The second demodulation path operates in essentially the same manner as the first demodulation path except that it is used for demodulating a second bit stream 549 corresponding to audio encoded information received in second time slots (as opposed to demodulating a first bit stream 529 corresponding to audio encoded information received in first time slots). For sake of brevity the operation of the second demodulation path for demodulating the second bit stream 549 will not be repeated. The complex gain module 558 controls gain applied to the second bit stream 549 that is received in the second time slot (slot 1) 422 to generate a second gain-adjusted bit stream 552. The demodulation and FEC module 554 demodulates and performs FEC on the second gain-adjusted bit stream 552 (that is received in the second time slot (slot 0) 422) to recover the second bit stream 556 of audio encoded bits and soft error control information corresponding to the second encoded audio frame.

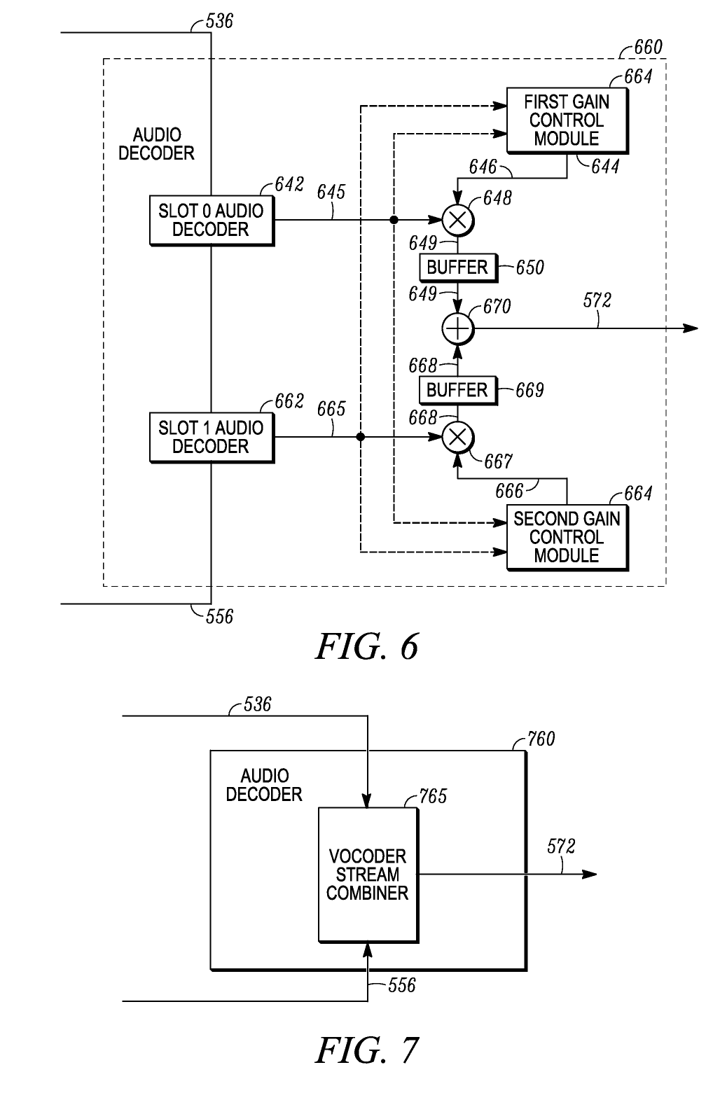

The audio decoder module 560 decodes the first bit stream 536 and the second bit stream 556 and combines them to generate a single audio stream 572 of digital audio samples. The decoding performed by audio decoder module 560 to generate the single audio stream 572 varies depending on the implementation. The audio decoder module 560 processes each frame of audio encoded bits for a particular time slot to generate a corresponding frame of synchronized speech samples. In one embodiment, each time slot is 30 milliseconds in duration, but includes 60 milliseconds of audio information or 480 digitized audio samples. When time slot 0 is received, 60 milliseconds of audio information (or 480 digitized audio samples) are generated and held in a buffer (not illustrated) that can be implemented in the audio decoder 560. Similarly, when time slot 1 is received, 30 milliseconds after time slot 0, 60 milliseconds of audio information (or 480 additional digitized audio samples) are generated and held in another buffer (not illustrated) that can also be implemented in the audio decoder 560. The speech samples can then be combined to generate a digital speech signal 572 that comprises a bit stream of digital audio/speech samples. In one embodiment, when all of the digitized audio samples are generated and buffered, then the audio decoder 560 of the receiving radio unit can sum digitized audio sample 0 from time slot 0 and digitized audio sample 0 from time slot 1, then sum digitized audio sample 1 from time slot 0 and digitized audio sample 1 from time slot 1, then sum digitized audio sample 2 from time slot 0 and digitized audio sample 2 from time slot 1, . . . , then sum digitized audio sample X from time slot 0 and digitized audio sample X from time slot 1, and then sum digitized audio sample 479 from time slot 0 and digitized audio sample 479 from time slot 1. Two particular implementations of the audio decoder module 560 will be described below with reference to FIGS. 6 and 7.

The audio decoder module 560 is coupled to the digital-to-analog converter module 574. The digital-to-analog converter module 574 converts the single audio stream 572 of digital audio samples into a single analog audio signal 576 (e.g., an audio speech signal that includes audio content from both of the transmitting radio units.).

The digital-to-analog converter module 574 may be coupled to the optional amplifier module 578, which can then be coupled to the speaker 582, or may be coupled directly to the speaker. In some implementations, the amplifier module 578 is required to amplify the analog audio signal 576 prior to providing it to the speaker 582. In other implementations, it is not required.

The speaker 582 receives the amplified single analog audio signal 580 and generates an acoustic signal 584. This acoustic signal 584 will include audio information that was transmitted from both radio units, thereby enabling a user of the receiving radio unit to simultaneously hear audio transmitted by the users of both radio units.

FIG. 6 is a block diagram illustrating an audio decoder module 660 that can be implemented at the receiver 500 of FIG. 5 in accordance with some of the disclosed embodiments.

As illustrated in FIG. 6, in some embodiments, the audio decoder module 660 includes a first audio decoder module 642 coupled to a first mixer 648, a first gain control module 644, a second audio decoder module 662 coupled to a second mixer 667, a second gain control module 664, and a summer module 670.

The first audio decoder module 642 decodes the first bit stream 536, and provides a first decoded bit stream 645 (e.g., of Pulse-code modulation (PCM) samples) to the first mixer 648. The first mixer 648 is coupled to the first gain control module 644 so that a first constant or variable gain 646 can be applied to the first decoded bit stream 645 at the first mixer 648 to generate a first stream 649 of gain-adjusted digitized audio samples. In one implementation, the gain applied by the first gain control module 644 to the first decoded bit stream 645 at the first mixer 648 can be a constant (e.g., 0.5). In other implementations, automatic gain control techniques can be implemented so that the first gain control module 644 can use information provided as part of the first decoded bit stream 645 and the second decoded bit stream 665 to generate a variable gain signal 646 that is applied to the first decoded bit stream 645 at mixer 648 to generate the first stream 649 of gain-adjusted, digitized audio samples with optimized dynamic range so that they can be processed by the digital-to-analog converter module 574 of FIG. 5. When automatic gain control techniques are implemented, the gain is determined by taking a time average of the square of the audio amplitude and comparing that to a reference value. In one embodiment, each 30 millisecond time slot includes a number (e.g., 480) of digitized audio samples that represent 60 milliseconds of audio information. The gain-adjusted, digitized audio samples for the first stream 649 can be held in a buffer 650 that can be implemented in the audio decoder 660.

The second audio decoder module 662 separately decodes the second bit stream 556, and provides a second decoded bit stream 665 to the second mixer 667. The second mixer 667 is coupled to the second gain control module 664 so that a constant or variable gain can be applied to the second decoded bit stream 665 at the second mixer 667 to generate a second stream 668 of gain-adjusted, digitized audio samples with optimized dynamic range so that they can be processed by the digital-to-analog converter module 574 of FIG. 5. The second gain control module 664 can operate similar to the first gain control module 644 as described above. The gain-adjusted, digitized audio samples for the second stream 667 can be held in a buffer 669 that can be implemented in the audio decoder 660

The first mixer 648 and the second mixer 667 are both coupled to the summer module 670. The summer module 670 can then sum the first and second streams 649, 668 of digitized audio samples to generate a single audio stream 572 of digital audio samples that is provided to the D/A converter module 574 of FIG. 5. Once all of the digitized audio samples are generated and buffered, then a mixer 670 of the audio decoder 660 of the receiving radio unit can sum the corresponding digitized audio samples for each time slot. In particular, the mixer 670 can sum digitized audio sample 0 from time slot 0 and digitized audio sample 0 from time slot 1, then sum digitized audio sample 1 from time slot 0 and digitized audio sample 1 from time slot 1, then sum digitized audio sample 2 from time slot 0 and digitized audio sample 2 from time slot 1, . . . , then sum digitized audio sample X from time slot 0 and digitized audio sample X from time slot 1, and then sum digitized audio sample 479 from time slot 0 and digitized audio sample 479 from time slot 1.

FIG. 7 is a block diagram illustrating an audio decoder module 760 that can be implemented at the receiver 500 of FIG. 5 in accordance with some of the other disclosed embodiments.

As illustrated in FIG. 7, in some embodiments, the audio decoder module 760 includes a vocoder stream combiner (VSC) module 765 that generates a single audio stream 572 of digital audio samples based on the first bit stream 536 and the second bit stream 556. The VSC module 765 generates a first vocoders stream based on the first bit stream 536 and a second vocoders stream based on the second bit stream 556, and combines the vocoders streams to generate single audio stream 572 of digital audio samples. In one implementation, the VSC module 765 is one that is produced by Digital Voice Systems, Inc. (DVSI), 234 Littleton Road Westford, Mass. 01886 USA. The VSC module 765. The single audio stream 572 of digital audio samples is provided to the D/A converter module 574 of FIG. 5.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a non-transitory computer-readable storage medium having computer readable code stored thereon for programming a computer (e.g., comprising a processor) to perform a method as described and claimed herein. Non-transitory computer-readable media comprise all computer-readable media except for a transitory, propagating signal. Examples of such non-transitory computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method in a wireless communication system for processing transmissions from different radio units at a receiving radio unit, the method comprising:
transmitting first audio information from a first transmitting radio unit in a first time slot, and transmitting second audio information from a second transmitting radio unit in a second time slot;
receiving, at the receiving radio unit, radio frequency signals comprising: a first bit stream corresponding to the first audio information that was transmitted in the first time slot, and a second bit stream corresponding to the second audio information that was transmitted in the second time slot; and
generating, based on the first bit stream and the second bit stream, a single analog audio signal that comprises combined audio information corresponding to the first audio information and the second audio information.

2. A method according to claim 1, wherein the steps of transmitting, comprise:
transmitting a first audio encoded frame comprising the first audio information from a first transmitting radio unit in a first time slot, and then transmitting a second audio encoded frame comprising the second audio information from a second transmitting radio unit in a second time slot.

3. A method according to claim 2, wherein the step of receiving, comprises:
receiving, at the receiving radio unit, radio frequency signals comprising:
a first bit stream corresponding to the first audio information transmitted in the first encoded audio frame that was transmitted in the first time slot, and
a second bit stream corresponding to the second audio information transmitted in the second encoded audio frame that was transmitted in the second time slot.

4. A method according to claim 2, wherein the step of generating, comprises:
recovering a first bit stream of audio encoded bits corresponding to the first encoded audio frame and a second bit stream of audio encoded bits corresponding to the second encoded audio frame.

5. A method according to claim 4, wherein the step of recovering, comprises:
demodulating the first bit stream to generate the first bit stream of audio encoded bits corresponding to the first encoded audio frame; and
separately demodulating the second bit stream to generate a second bit stream of other audio encoded bits corresponding to the second encoded audio frame.

6. A method according to claim 4, further comprising:
separately decoding the first and second bit streams, to generate a first stream of digitized audio samples and a second stream of digitized audio samples; and
combining the first and second streams of digitized audio samples to generate a single audio stream of digital audio samples.

7. A method according to claim 6, further comprising:
converting the single audio stream of digital audio samples into a single analog audio signal.

8. A method according to claim 7, further comprising:
sending to the single analog audio signal to a speaker of the receiving radio unit to generate an acoustic signal.

9. A method according to claim 1, wherein the wireless communication system is a time division multiple access (TDMA)-based wireless communication system.

10. A method according to claim 1, wherein the wireless communication system is an orthogonal frequency division multiple access (OFDMA)-based wireless communication system.

11. A method according to claim 1, wherein the first time slot and the second time slot are consecutive time slots in a frame that are transmitted successively in time.

12. A method according to claim 1, wherein the first transmitting radio unit, the second transmitting radio unit and the at least one receiving radio unit are members of the same communication group.

13. A method according to claim 1, wherein the first transmitting radio unit, second transmitting radio unit and the receiving radio unit are communicating in talk-around mode without assistance of a base station.

14. A method according to claim 1, wherein the first transmitting radio unit is a wireless communication device or a base station, wherein the second transmitting radio unit is another wireless communication device or another base station.

15. A receiving radio unit that process transmissions from different radio units in a wireless communication system, the receiving radio unit comprising:
a receiver that receives radio frequency (RF) signals comprising: a first bit stream corresponding to first audio information that was transmitted in a first time slot from a first transmitting radio unit, and a second bit stream corresponding to second audio information that was transmitted in a second time slot from a second transmitting radio unit;
a processor that generates, based on the first bit stream and the second bit stream, a single analog audio signal that comprises combined audio information corresponding to the first audio information and the second audio information; and
a speaker that generates an acoustic signal based on the single analog audio signal.

16. A receiving radio unit according to claim 15, wherein the first audio information is transmitted as a first audio encoded frame from the first transmitting radio unit in the first time slot in, and wherein the second audio information is transmitted as a second audio encoded frame from the second transmitting radio unit in the second time slot.

17. A receiving radio unit according to claim 16, wherein the receiver receives radio frequency signals comprising:
a first bit stream corresponding to the first audio information transmitted in the first encoded audio frame that was transmitted in the first time slot, and
a second bit stream corresponding to the second audio information transmitted in the second encoded audio frame that was transmitted in the second time slot.

18. A receiving radio unit according to claim 16, wherein the processor recovers a first bit stream of audio encoded bits corresponding to the first encoded audio frame and a second bit stream of audio encoded bits corresponding to the second encoded audio frame.

19. A receiving radio unit according to claim 18, wherein the processor demodulates the first bit stream to generate the first bit stream of audio encoded bits corresponding to the first encoded audio frame, and separately demodulates the second bit stream to generate a second bit stream of other audio encoded bits corresponding to the second encoded audio frame.

20. A receiving radio unit according to claim 18, wherein the processor separately decodes the first and second bit streams, to generate a first stream of digitized audio samples and a second stream of digitized audio samples, and combines the first and second streams of digitized audio samples to generate the single audio stream of digital audio samples, wherein the processor comprises:
a converter module that converts the single audio stream of digital audio samples into the single analog audio signal.
